(19) United States
(12) Patent Application Publication
(10) Pub. No.: US 2025/0375643 A1
(43) Pub. Date: Dec. 11, 2025

(54) FIRE RETARDANT CONCENTRATE COMPOSITIONS CONTAINING A CARBOXYLIC ACID AND ONE OR MORE CORROSION INHIBITORS

(71) Applicant: PERIMETER SOLUTIONS LP, Clayton, MO (US)

(72) Inventors: Melissa KIM, Ontario, CA (US); Marcela MUNOZ, Fontana, CA (US); Jeremiah MACASAET, Fontana, CA (US)

(21) Appl. No.: 18/876,935

(22) PCT Filed: Jun. 27, 2023
(86) PCT No.: PCT/US2023/026314

§ 371 Date: Dec. 19, 2024

Related U.S. Application Data
(60) Provisional application No. 63/355,847, filed on Jun. 27, 2022.

(51) Int. Cl. A62D 1/00

(52) U.S. Cl. CPC A62D 1/0035

(57) ABSTRACT

The present invention generally relates to fire retardant compositions including one or more carboxylic acids and/or salts thereof, for example, one or more alkali metal salts of a carboxylic acid. In particular, the present invention relates to particulate fire retardant concentrate compositions (e.g., powder compositions) including one or more alkali metal salts of a carboxylic acid. The present invention also relates to methods for preparing the fire retardant compositions described herein.

### CROSS-REFERENCE TO RELATED APPLICATIONS

This application claims the benefit of, and priority to, U.S. Provisional Patent Application Ser. No. 63/355,847, filed Jun. 27, 2022, the entire contents of which are hereby incorporated by reference as if fully set forth herein.

### FIELD OF THE INVENTION

The present invention generally relates to fire retardant compositions including one or more carboxylic acids and/or salts thereof, for example, one or more alkali metal salts of a carboxylic acid. In particular, the present invention relates to particulate fire retardant concentrate compositions (e.g., powder compositions) including one or more alkali metal salts of a carboxylic acid. The present invention also relates to methods for preparing the fire retardant compositions described herein. Various aspects of the present invention also include liquid fire retardant concentrate compositions.

### BACKGROUND OF THE INVENTION

Compositions including inorganic salts are known for use as fire retardant compositions. These include, for example, those based on ammonium phosphate-based fire retardants, including those containing ammonium polyphosphate (APP), monoammonium phosphate (MAP), and/or diammonium phosphate (DAP). In fact, various such fire retardants have been developed and used safely and effectively for years, even decades. However, alternatives may be desired for a variety of reasons. For example, although ammonium phosphate-based fire retardants are safe and environmentally friendly, certain consumers or regulatory bodies may consider fire retardant compositions based on organic fire retardants desirable in certain circumstances. Although inorganic retardant-containing compositions have been developed and employed successfully, there exists a desire in the art for development of fire retardant compositions based on organic retardant components.

Moreover, fire retardant compositions are typically employed as liquid fire retardant concentrate compositions and have been developed and utilized effectively on a commercial scale for years, even decades. In certain instances, however, particulate, or powdered concentrate compositions may be desired to provide certain advantages in terms of packaging, storage, and processing. There exists a further need in the art, therefore, for alternative particulate (e.g., powder) fire retardant concentrate compositions.

### BRIEF SUMMARY OF THE INVENTION

In various aspects, the present invention includes fire retardant compositions containing at least one salt of a carboxylic acid (e.g., an alkali metal salt of a tri-carboxylic acid) and a carboxylic acid (e.g., a tri-carboxylic acid that may the same or different from the carboxylic acid of the salt) along with other components providing one or more advantageous properties (e.g., one or more corrosion inhibitors). Various aspects involve such fire retardant compositions in particulate (e.g., powdered) form.

Certain aspects of the present invention involve a fire retardant concentrate (e.g., a particulate or powdered concentrate) comprising: an alkali metal salt of a tri-carboxylic acid, wherein the alkali metal salt of the tri-carboxylic acid constitutes at least about 80 wt % of the concentrate; a tri-carboxylic acid, wherein the tri-carboxylic acid constitutes from about 1 wt % to about 2 wt % of the concentrate; and a corrosion inhibitor component. In various embodiments, the corrosion inhibitor component comprises a silicate-based corrosion inhibitor selected from the group consisting of calcium phosphosilicate, calcium strontium phosphosilicate, calcium sodium phosphosilicate, and modified calcium phosphosilicates, and combinations thereof.

Other aspects of the present invention involve a fire retardant concentrate comprising: an alkali metal salt of a tri-carboxylic acid, wherein the alkali metal salt of the tri-carboxylic acid constitutes at least about 80 wt % of the concentrate; a tri-carboxylic acid, wherein the tri-carboxylic acid constitutes at least about 0.5 wt % of the concentrate; and a corrosion inhibitor component, wherein the corrosion inhibitor component comprises a silicate-based corrosion inhibitor selected from the group consisting of calcium phosphosilicate, calcium strontium phosphosilicate, calcium sodium phosphosilicate, and modified calcium phosphosilicates, and combinations thereof, and wherein the weight ratio of the silicate-based corrosion inhibitor to the tri-carboxylic acid is at least 1.8:1.

Further aspects of the present invention involve a fire retardant concentrate comprising: an alkali metal salt of a tri-carboxylic acid; a tri-carboxylic acid; and a corrosion inhibitor component comprising a silicate-based corrosion inhibitor, wherein: the weight ratio of the alkali metal salt of the tri-carboxylic acid to the tri-carboxylic acid is at least 40:1.

Still further aspects of the present invention involve a powder fire retardant concentrate comprising: an alkali metal salt of a tri-carboxylic acid; a tri-carboxylic acid; a thickener; a corrosion inhibitor component comprising an azole corrosion inhibitor and a molybdate corrosion inhibitor, wherein the weight ratio of the azole corrosion inhibitor to molybdate corrosion inhibitor is at least about 1:1, from about 1:1 to about 2:1, or about 1.5:1; and a flow conditioner.

Aspects of the present invention are also directed to a powder fire retardant concentrate comprising: an alkali metal salt of a tri-carboxylic acid, wherein the tri-carboxylic acid is selected from the group consisting of citric acid, isocitric acid, aconitic acid, agaric acid, trimesic acid, propane 1, 2, 3 tricarboxylic acid, and combinations thereof; a thickener selected from the group consisting of xanthan gum, rhamsan gum, welan gum, diutan gum, guar gum, and combinations thereof; a corrosion inhibitor selected from the group consisting of azole corrosion inhibitors, molybdate corrosion inhibitors, and combinations thereof; and a flow conditioner, wherein the flow conditioner is selected from the group consisting of oxide flow conditioners, silica flow conditioners, cellulose containing flow conditioners, and combinations thereof.

In accordance with the foregoing aspects of the present invention, in various embodiments, additionally or alternatively, the corrosion inhibitor comprises one or more phosphate-based inhibitors described herein.

Other objects and features will be in part apparent and in part pointed out hereinafter.

### DETAILED DESCRIPTION OF THE INVENTION

In accordance with the present invention, it has been discovered that particulate (e.g., powdered) fire retardant concentrates containing a salt of a carboxylic acid, in particular a salt of a tri-carboxylic acid, along with a carboxylic acid and other components can be prepared that are effective in terms of their fire retardant effect and the ability to provide low metal corrosion meeting the current standards. Although fire retardant compositions providing equivalent fire retardant ability and metal corrosion to present fire retardants are commercially available, one advantage of the present fire retardants is being based on an organic carboxylic acid. For example, as compared to ammonium phosphate-based retardants, the retardant compositions of the present invention based on an organic fire retardant component may require a greater proportion of fire retardant, a benefit is provided nonetheless by virtue of the fire retardant being based on an organic component. By way of further example, as compared to certain magnesium chloride-based fire retardants, less of the organic-based fire retardant may be required thus providing advantages in terms of both the amount and nature of the fire retardant component.

The fire retardant concentrate compositions in particulate (e.g., powdered) form provide advantages in terms of ease of storage, storage stability, ease of mixing, etc. It is to be understood that reference to a particulate fire retardant concentrate composition meeting applicable metal corrosion standards indicates a fire retardant solution prepared from the concentrate in accordance with the applicable standards satisfies the metal corrosion standards.

Moreover, although the following discussion focuses on particulate fire retardant concentrate compositions it is to be understood the present invention also includes liquid fire retardant concentrate compositions containing one or more of the components described herein incorporated, for example, in the prescribed ratios.

### Fire Retardant/Carboxylic Acid Salt

Generally, the compositions of the present invention include as a fire retardant component a salt of a carboxylic acid, in particular a salt of a tri-carboxylic acid.

Suitable tri-carboxylic acids include, for example, citric acid, isocitric acid, aconitic acid, agaric acid, trimesic acid, propane 1,2,3-tricarboxylic acid, and combinations thereof. In various aspects of the present invention, a salt of citric acid is utilized.

Suitable cations for the salt of the carboxylic acid are typically selected from alkali metals of the group consisting of lithium, sodium, potassium, calcium, cesium, rubidium, and combinations thereof. In various aspects, the cation is sodium or potassium. In certain aspects, the cation is potassium. Thus, in various aspects the present compositions incorporate a potassium salt of a tri-carboxylic acid (e.g., a potassium salt of citric acid, including tri-potassium citrate).

Typically, the tri-carboxylic acid constitutes at least about 80 wt %, at least about 81 wt %, at least about 82 wt %, at least about 83 wt %, at least about 84 wt %, or at least about 85 wt % of the concentrate. Generally, the tri-carboxylic acid constitutes a proportion of the concentrate above one of the lower limits listed above and/or below an upper limit of less than about 95 wt %, less than about 93 wt %, less than about 91 wt %, less than about 89 wt %, less than about 87 wt %, or less than about 85 wt %.

### Carboxylic Acid

Along with the carboxylic acid salt, a carboxylic acid is typically incorporated into the composition of the present invention as a fire retardant component as well. The carboxylic acid may be the same, or different from the carboxylic acid of the alkali metal salt fire retardant component. In various aspects, therefore, the composition includes citric acid, while in others it includes a different carboxylic acid selected from, for example, isocitric acid, aconitic acid, agaric acid, trimesic acid, propane 1,2,3-tricarboxylic acid, and combinations thereof.

Typically, the carboxylic acid (e.g., tri-carboxylic acid) constitutes at least about 1 wt %, at least about 1.1 wt %, at least about 1.2 wt %, at least about 1.3 wt %, at least about 1.4 wt %, at least about 1.5 wt %. Generally, the carboxylic acid is present at such minimum concentration levels and at a concentration of no more than about 2 wt %, no more than about 1.9 wt %, no more than about 1.8 wt %, no more than about 1.7 wt %, or no more than about 1.6 wt %.

In accordance with the present invention, it has been discovered that incorporation of the tri-carboxylic acid contributes to improvements in metal corrosion. Thus, for compositions being formulated where potential issues with metal corrosion may be encountered adjusting the concentration of acid may be advisable. In various aspects, it has been discovered that incorporating the carboxylic acid (e.g., citric acid) at a concentration of at least about 1 wt %, or at least about 1.1 wt % may provide particular benefit in this regard. Without being bound to any particular theory, the tri-carboxylic acid may act as a buffer and/or chelating agent, which may contribute to the corrosion inhibiting effect.

Additionally, or alternatively in accordance with the above discussion regarding the carboxylic acid salt and carboxylic acid as separate components, in various aspects of the present invention the carboxylic acid salt and carboxylic acid are present in a weight ratio of salt: acid of at least about 40:1, at least about 45:1, at least about 50:1, at least about 55:1, at least about 60:1, or at least about 65:1 (e.g., 40:1 to about 75:1, from about 40:1 to about 70:1, or from about 50:1 to about 70:1).

### Corrosion Inhibitor

Typically, the compositions of the present invention include a corrosion inhibitor constituted by and/or comprising one or more corrosion inhibitors.

Typically, the corrosion inhibitor component constitutes at least about 3 wt %, at least about 3.1 wt %, at least about 3.2 wt %, at least about 3.3 wt %, at least about 3.4 wt %, or at least about 3.5 wt %. Generally, the corrosion inhibitor component constitutes from about 3 wt % to about 6 wt %, from about 3 wt % to about 5.5 wt %, from about 3 wt % to about 5 wt %, or from about 3 wt % to about 4 wt % of the composition. In various embodiments, the corrosion inhibitor constitutes from about 3.5 wt % to about 4.0 wt % (e.g., from about 3.6 wt % to about 3.8 wt %, or about 3.75 wt %) of the composition. In still other embodiments, the corrosion inhibitor constitutes from about 4.75 wt % to about 5.25 wt % (e.g., about 5.0 wt %).

Generally, suitable silicate-based corrosion inhibitors include those containing one or more alkali metals selected from the group consisting of lithium, sodium, potassium, calcium, cesium, rubidium, and combinations thereof.

In various embodiments, the silicate corrosion inhibitor comprises calcium (e.g., calcium silicate). Suitable calcium-containing phosphosilicates as corrosion inhibitors include calcium strontium phosphosilicate (e.g., NUBRIOX 301), calcium phosphosilicates (e.g., CW-491 and HMH) and modified calcium phosphosilicates (e.g., HABICOR CS), and combinations thereof.

In other embodiments, the silicate corrosion inhibitor comprises sodium. For example, in certain embodiments, the corrosion inhibitor comprises sodium silicate, sodium metasilicate, and combinations thereof.

In still further embodiments, the silicate corrosion inhibitor comprises calcium and sodium. Suitable calcium and sodium containing phosphosilicates include, for example, calcium sodium phosphosilicates such as NOVAMIN calcium sodium phosphosilicate.

Suitable potassium containing silicate-based corrosion inhibitors include potassium silicate.

In still other embodiments, the silicate-based corrosion inhibitor may comprise one or more alkaline earth metals (e.g., barium, and/or strontium). For example, in certain such embodiments, the corrosion inhibitor comprises barium phosphosilicate and/or strontium phosphosilicate.

Further in accordance with the present invention, a silicate-based corrosion inhibitor may comprise a transition metal (e.g., zinc). For example, the corrosion inhibitor may comprise zinc silicate.

Still further in accordance with the present invention, the silicate-based corrosion inhibitor may comprise one or more of the types of metals listed above (e.g., an alkaline earth metal and a transition metal, or each of an alkali metal, alkaline earth metal, and transition metal). Suitable examples include strontium zinc phosphosilicate and zinc strontium calcium phosphosilicate.

Typically, any (phospho) silicate-based corrosion inhibitor is incorporated at a concentration of at least about 2.5 wt %, at least about 2.6 wt %, at least about 2.7 wt %, at least about 2.8 wt %, at least about 2.9 wt %, at least about 3.0 wt %. For example, a silicate-based corrosion inhibitor may be incorporated in a concentration of from about 2.5 wt % to about 4 wt %, or from about 3 wt % to about wt %.

Overall, on the basis of total corrosion inhibitor content, any silicate-based corrosion inhibitor typically constitutes at least about 50 wt %, at least about 60 wt %, at least about 70 wt %, at least about 75 wt %, or even at least about 80 wt % of the total corrosion inhibitor content.

In various aspects, the weight ratio of the silicate-based corrosion inhibitor to the tri-carboxylic acid is at least 1.8:1, at least about 1.9:1, at least about 2:1, at least about 2.1:1, at least about 2.2:1, at least about 2.3:1, at least about 2.4:1, at least about 2.5:1, at least about 2.6:1, at least about 2.7:1, at least about 2.8:1, at least about 2.9:1, or at least about 3:1.

In accordance with various aspects of the present invention, it has been discovered that incorporation of a silicate-based corrosion inhibitor may provide improved metal corrosion properties. It is currently believed that silicates function to improve corrosion performance by forming a protective oxide layer that acts as a barrier to oxygen diffusion to the metal surface. For example, silicate-based corrosion inhibitors have been observed to provide advantageous steel and aluminum metal corrosion properties in connection with fire retardant solutions prepared incorporating such a concentrate. Fire retardant solutions incorporating such corrosion inhibitors are thus suitable for use and regulatory approval in connection with fixed wing aircraft. Various such embodiments incorporate calcium phosphosilicate, and/or calcium sodium phosphosilicate as the corrosion inhibitor.

Various embodiments of the present invention involve use of a silicate-based corrosion inhibitor that also provides advantageous magnesium corrosion properties. Such embodiments are particularly suitable for providing advantageous magnesium corrosion properties, thus rendering them suitable for use and regulatory approval in connection with helicopters. In accordance with various such embodiments, the corrosion inhibitor comprises calcium sodium phosphosilicate.

Other suitable corrosion inhibitors include phosphate-based corrosion inhibitors including an alkali metal, alkaline earth metal, and or transition metal.

Suitable phosphate-based corrosion inhibitors may include an alkali metal selected from the group consisting of calcium, potassium, and sodium. For example, suitable corrosion inhibitors include calcium phosphate (e.g., hydroxyapatite), calcium orthophosphate (ACP), potassium tripolyphosphate (KTPP), sodium dihydrogen phosphate, and combinations thereof.

In further embodiments, a phosphate-based corrosion inhibitor may include an alkaline earth metal such as magnesium (e.g., magnesium phosphate, and magnesium phosphate dibasic trihydrate) and/or strontium.

Other phosphate-based corrosion inhibitors may include a transition metal selected from the group consisting of, for example, zinc, iron, and combinations thereof. For example, suitable phosphate-based corrosion inhibitors include zinc phosphate, ferric pyrophosphate, and combinations thereof.

Further phosphate-based corrosion inhibitors may include more than one of the metals listed above. For example, suitable phosphate-based corrosion inhibitors include calcium aluminum polyphosphate (CAPP), calcium magnesium phosphate (CMP), strontium aluminum polyphosphate (SAPP), and combinations thereof.

Citrate-based corrosion inhibitors also may be used in accordance with the present invention. Suitable citrate-based corrosion inhibitors include calcium citrate.

Phosphate-based corrosion inhibitors can be incorporated into the compositions of the present invention in accordance with the foregoing discussing regarding suitable concentrations.

Typically, the compositions of the present invention include a corrosion inhibitor constituted by and/or comprising one or more corrosion inhibitors. Options for corrosion inhibitors include azole corrosion inhibitors and molybdate corrosion inhibitors. Thus, in various aspects one or more corrosion inhibitors selected from azole corrosion inhibitors and/or molybdate corrosion inhibitors.

Suitable azole corrosion inhibitors include benzotriazole, tolytriazole, dimercapto thiadiazole and combinations thereof.

Suitable molybdate corrosion inhibitors include sodium molybdate, potassium molybdate, lithium molybdate, calcium molybdate, and combinations thereof. In certain embodiments, the corrosion inhibitor comprises calcium molybdate.

Where each are incorporated, the weight ratio of the azole corrosion inhibitor to molybdate corrosion inhibitor typically is at least about 1:1, from about 1:1 to about 2:1, or about 1.5:1.

### Flow Conditioner

The particulate (e.g., powdered) compositions may be prone to clumping. To address this concern, the concentrate compositions of the present invention typically incorporate a flow conditioner. It is currently believed the presence of the flow conditioner contributes advantageous properties to the powdered concentrates. More particularly, it is currently believed the particular flow conditioner selected, its proportion, relative proportion to the fire retardant component, etc. contribute to the advantageous performance of the powder concentrates of the present invention. Typically, the flow conditioner has an average particle size of at least about 2 microns (μm), at least about 10 μm, at least about 25 μm, at least about 50 μm, at least about 75 μm, or at least about 100 μm. In certain embodiments, the flow conditioner has an average particle size of from about 2 μm to about 17 μm or from about 44 μm to about 105 μm. Additionally, or alternatively, such particle sizes may be based on the average particle size for a particular fraction of the flow conditioner, e.g., at least about or about 75 wt %, at least about or about 85 wt %, at least about or about 95 wt %, and/or at least about or about 99 wt %.

Typically, the flow conditioner is selected from the group consisting of oxide flow conditioners, silica flow conditioners, cellulose containing flow conditioners, and combinations thereof.

Generally, the flow conditioner is present in a proportion of at least about 0.1 wt %, at least about 0.25 wt %, at least about 0.5 wt %, at least about 0.75 wt %, at least about 1 wt %, at least about 1.25 wt %, at least about 1.5 wt %., at least about 2 wt %, at least about 3 wt %, or even at least about 4 wt %. In various embodiments, the flow conditioner is present in a proportion of from about 0.25 wt % to about 5 wt %, from about 0.25 wt % to about 4 wt %, from about 0.25 wt % to about 3 wt %, from about 0.5 wt % to about 3 wt %, from about 0.5 wt % to about 2 wt %, from about 0.5 wt % to about 1.75 wt %, from about 0.75 wt % to about 1.5 wt %, or from about 1 wt % to about 1.5 wt.

Suitable oxide flow conditioners include magnesium oxide, sodium dioxide, calcium oxide, silicon dioxide, and combinations thereof. In various embodiments, the flow conditioner is magnesium oxide. In certain embodiments, the flow conditioner comprises silicon dioxide. Silica dioxide-containing flow conditioners include silicas such as untreated fumes silica and micronized silica. Options of commercially available sources of flow conditioner include the following silicon dioxide flow conditioners: ZEOFREE 80, 110SD, 200, 5161, 5162, 265, 5191, 5193, and 5170.

Suitable cellulose containing flow conditioners are selected from the group consisting of ground rice hulls, a starch selected from potato, tapioca, and corn, bamboo powder, bamboo fiber, wheat powder, wheat fiber, oat powder, oat fiber, and combinations thereof. In certain embodiments, the flow conditioner comprises ground rice hulls.

### Thickener

The concentrate compositions of the present invention further comprise one or more thickeners. In various embodiments, the thickener is selected from the group consisting of latex, styrene, butadiene, polyvinyl alcohol, attapulgite, bentonite, montmorillonite, algin, collagen, casein, albumin, castor oil, cornstarch, arrowroot, yuca starch, carrageenan, pullulan, konjac, alginate, gelatin, agar, pectin, carrageenan, chitosan, xanthan gum, guar gum, rhamsan gum, diutan gum, welan gum, cellulose gum, acacia guar gum, locust bean gum, acacia gum, gum tragacanth, glucomannan polysaccharide gum, alginic acid, sodium alginate, potassium alginate, ammonium alginate, calcium alginate, carboxymethyl cellulose (CMC), methyl cellulose, hydroxyethyl cellulose (HEC), hydroxymethyl cellulose (HMC), hydroxypropyl methylcellulose (HPMC), ethyl hydroxyethyl cellulose, hypromellose (INN), cetyl alcohol, cetearyl alcohol, polyethylene glycol (PEG), monoethylene glycol, acrylic microgel, or acrylic amide wax.

In particular, representative examples of thickeners include xanthan gum, rhamsan gum, welan gum, diutan gum, guar gum, and mixtures thereof. In certain embodiments, the thickener is xanthan gum.

The thickener is typically present in a proportion of at least about 1 wt %, at least about 1.5 wt %, at least about 2 wt %, at least about 2.5 wt %, at least about 3 wt %, or at least about 3.5 wt %. Often, the thickener is present in a proportion of from about 1 wt % to about 8 wt %, from about 2 wt % to about 6 wt %, from about 3 wt % to about 5 wt %, or from about 3 wt % to about 4 wt %.

### Pigment/Dye/Color System

Generally, the concentrates of the present invention may be uncolored, include a pigment (e.g., iron oxide), or be colored with a fugitive pigment. A fugitive color system may be present in a concentration of from about 1 wt % to about 3.5 wt %, from about 1.5 wt % to about 3.5 wt % (e.g., about 1.7 wt %).

In certain aspects, the pigment or dye comprises red iron oxide, brown iron oxide, titanium dioxide or a fugitive pigment or dye. In some embodiments, the pigment or dye can comprise a fugitive color system.

In some embodiments, the fugitive color system comprises a fugitive pigment and a water insoluble opaque material (e.g., an opacifier such as zinc ferrite).

Suitable color systems are described in U.S. Pat. No. 11,679,290 (Attorney Docket No. 18931B-000002-US) and U.S. Patent No, 11, 142,698 (Attorney Docket No. 18931B-000022-US) the entire contents of which are incorporated herein by reference for all relevant purposes.

Typically, any dye or colorant is present in the concentrate at a concentration of from about 0.15 wt % to about 0.35 wt %, or about 0.15 wt % of the concentrate. For example, iron oxide may be present in a concentration of from about 0.15 wt % to about 1.5 wt %, or from about 0.15 wt % to about 0.35 wt %.

For example, suitable fugitive pigment color systems include those described in U.S. Pat. No. 11,142,698, the entire contents of which are incorporated by reference herein for all relevant purposes.

Surfactants

Along with the components listed above, the concentrates of the present invention may optionally further include a surfactant. Typically, any surfactant constitutes from about 0.10 wt % to about 0.50 wt %, from about 0.10 wt % to about 0.40 wt %, or from about 0.10 wt % to about 0.30 wt %. Suitable surfactants include nonionic surfactants including, for example, PLURONIC L-101.

### Additional Fire Retardants

Optionally, an additional fire retardant may be incorporated into the compositions of the present invention. These include, for example, ammonium phosphate-based fire retardants (e.g., monoammonium phosphate (MAP), diammonium phosphate (DAP), and ammonium polyphosphate (APP)), and magnesium chloride.

### Fire Retardant Solutions

As noted, the present compositions (e.g., particulate fire retardant concentrates) are diluted for use to form a fire retardant solution. Typically, the solution (e.g., diluted concentrate) contains from 5 wt % to about 20 wt % carboxylic acid salt (e.g., from about 5 wt % to about 15 wt %, or about 10 wt %).

As noted above, a tri-carboxylic acid salt and another tri-carboxylic acid, which may be the same or different than the acid of the salt is incorporated. Such an acid may be incorporated in either the anhydrous or monohydrate form.

Often, the acid of the salt and the separate acid are the same tri-carboxylic acid. Given the less than molar proportion of salt cation to the total proportion of the acid, a diluted concentrate thus may be described as incorporating an under-neutralized carboxylic acid salt.

Provided for herein are fire-retardant solutions prepared by mixing a fire-retardant concentrate composition, as described herein, with water to form an aqueous solution.

In certain embodiments, the solution is prepared by combining at least about 0.5 pounds (lbs.) at least about 0.6 lbs., at least about 0.7 lbs., at least about 0.8 lbs. at least about 0.9 lbs., at least about 1.0 lb., at least about 1.5 lbs., or at least 2 lbs. of fire retardant concentrate per gallon of water.

In certain embodiments, a fire-retardant solution may exhibit an aluminum corrosion rate equal to or less than 2.0 milli-inches or less than 1.0 milli-inches per year. In certain embodiments, a fire-retardant solution may exhibit a mild steel corrosion rate equal to or less than 5.0 milli-inches per year. In certain embodiments, a fire-retardant solution may exhibit a brass corrosion rate equal to or less than 5.0 milli-inches per year. In certain embodiments, a fire-retardant solution may exhibit two or more of the above-described corrosion rates for magnesium, aluminum, mild steel and/or brass.

In certain embodiments, a fire-retardant solution may meet one or more of the required criteria for of U.S. Department of Agriculture, Forest Service, Specification Number 5100-304d, January 2020, including any and all amendments.

In certain embodiments, a fire-retardant solution may meet one or more of the required criteria for corrosion and/or stability of U.S. Department of Agriculture, Forest Service, Specification Number 5100-304d, January 2020, including all amendments.

In certain embodiments, a fire-retardant solution may meet all of the required criteria for corrosion of U.S. Department of Agriculture, Forest Service, Specification Number 5100-304d, January 2020, including all amendments.

In certain embodiments, a fire-retardant solution may meet all of the required criteria for stability of U.S. Department of Agriculture, Forest Service, Specification Number 5100-304d, January 2020, including all amendments.

In certain embodiments, a fire-retardant solution may meet all of the required criteria for corrosion and stability of U.S. Department of Agriculture, Forest Service, Specification Number 5100-304d, January 2020, including all amendments.

In certain embodiments, a fire-retardant solution may meet all of the required criteria of U.S. Department of Agriculture, Forest Service, Specification Number 5100-304d, January 2020, including all amendments.

For example, Specification 5100-304d (Jan. 7, 2020) establishes the maximum allowable corrosion rates for aluminum (2024T3), steel (4130), yellow brass, and magnesium (Az-31-B). The maximum corrosivity of fire retardants, in concentrate, to aluminum, steel, yellow brass, and magnesium is 5.0 milli-inches (mils) per year as determined by the Uniform Corrosion test of Section 4.3.5.1 of the USFS Specification. The corrosion Specification also includes measuring the corrosion when each of a concentrate and solution are exposed to each metal at temperatures above 120° F., both partially and totally submerged. Partial submersion involves one-half of the coupon being immersed within the solution and one-half of the coupon being exposed to the vapors in the air space over the solution. The maximum corrosivity of aerially-applied fire-retardant solutions (i.e., diluted concentrates) is 2.0 mils per year (mpy) for aluminum, 2.0 mpy for brass and steel when partially immersed and 5.0 mpy when totally immersed.

It is currently believed that concentrates and solutions prepared from dilution of powdered concentrates of the present invention may meet any or all of these criteria.

In certain embodiments, the fire-retardant solution exhibits a viscosity in the range of from about 100 cPs to about 1500 cPs (e.g., from about 150 cPs to about 150 cPs), from about 100 cPs to about 1000 cps, or from about 100 cPs to about 800 cPs, or from about 100 cPs to about 300 cPs when measured in accordance with Specification 5100-304d, January 2020, including any and all amendments.

Typically, fire retardant solutions of the present invention have a pH of at least about 6.0, at least about 6.2, at least about 6.3, at least about 6.5, at least about 6.8, or at least about 7.0. For example, in various embodiments, the fire retardant solution has a pH of from about 6.5 to about 7.5 (e.g., from about 6.6 to about 7.4, or from about 6.8 to about 7.2).

In various other embodiments, the present fire retardant solutions may exhibit higher pH of for example, at least about 7.5, at least about 8.5, at least about 9.0, at least about 9.5, or at least about 10.0, and typically above one of these lower limits and above an upper limit of about 11.0 or about 10.5 (e.g., from about 9.5 to about 10.5). Without being bound to any particular theory, it is currently believed that fire retardant solutions having relatively higher pHs may provide improved metal corrosion properties in connection with certain corrosion inhibitors. For example, it is currently believed improved metal corrosion properties may be provided by higher pH solutions containing a corrosion inhibitor containing multiple metals (e.g., calcium and sodium such as, for example, calcium sodium phosphosilicate).

### Liquid Fire Retardant Concentrates

The present invention also includes liquid fire retardant concentrates prepared by diluting the particulate (e.g., powder) concentrates described herein to provide a liquid fire retardant concentrate. Given that such concentrates involve partial dilution prior to forming the fire retardant solution for use, they may be termed intermediate liquid concentrates. Such concentrates typically contain from about 10 to about 50% by weight, from about 30% to about 50%, or from about 40% to about 50% by weight water.

### Methods of Combatting Fires

Disclosed herein are methods of combatting a wildfire by applying a fire-retardant solution prepared from a concentrate of the present invention described anywhere herein for the purpose of suppressing, containing, controlling, or extinguishing, etc., a wildfire. In certain embodiments, the fire-retardant solution is applied directly onto a flaming fuel. In other embodiments, the fire-retardant solution is applied indirectly, e.g., in front of or parallel to the moving fire front. The distance between the advancing fire and the retardant fire-break depends on the rate that the solution can be applied, the rate of spread of the moving fire front, and the presence or absence of a natural fuel break identified by changes in the geometry of the ground being threatened. In certain embodiments, the fire-retardant solution is applied from a ground platform such as a fire-engine. In certain embodiments, the fire-retardant solution is applied from an aerial platform such as a fixed-wing aircraft or a rotary-wing aircraft. For example, in certain embodiments, the fire-retardant solution is applied from a rotary-wing aircraft such as a helicopter utilizing a bucket which is slung below the helicopter and in other embodiments the fire-retardant solution is contained within tanks mounted in or attached externally to the helicopter. In other embodiments, the fire retardant solution is applied from a mix of all of those listed vehicles or platforms. Obviously, the safety of the solution relative to aircraft corrosion and fouling of critical components must be greater when the solution is within or in contact with the aircraft.

Having described the invention in detail, it will be apparent that modifications and variations are possible without departing from the scope of the invention defined in the appended claims.

### EXAMPLES

The following non-limiting examples are provided to further illustrate the present invention.

### Example 1

The following examples describe compositions A-E. Compositional details for both the concentrate as prepared and a diluted solution prepared therefrom are given. Also provided are the results of metal corrosion testing for these compositions.

| | A | | B | |
|---|---|---|---|---|
| | | % | | % |
| | % | Dilute | % | Dilute |
| Tripotassium citrate | 84.61 | 10.02 | 85.43 | 10.03 |
| Fugitive pigment | 2.70 | 0.32 | 2.70 | 0.32 |
| Iron Oxide | 0.25 | 0.03 | 0.25 | 0.03 |
| Xanthan | 3.79 | 0.45 | 3.79 | 0.45 |
| Tolyltriazole | 0.25 | 0.03 | 0.25 | 0.03 |
| Sodium molybdate | 0.17 | 0.02 | 0.17 | 0.02 |
| Tricalcium phosphate | 1.25 | 0.15 | 1.25 | 0.15 |
| Dimercaptothiadiazole | 1.69 | 0.20 | 1.69 | 0.20 |
| Citric Acid | 2.11 | 0.25 | 1.25 | 0.15 |
| Calcium Phosphosilicate | 3.02 | 0.36 | 3.05 | 0.36 |
| Surfactant | 0.17 | 0.02 | 0.17 | 0.02 |
| Total | 100 | | 100 | |

| Calcium | 1.43 | 2.44 |
|---|---|---|
| Phosphosilicate:Citric | | |
| Acid | | |
| Citric Acid:Calcium | 0.70 | 0.41 |
| Phosphosilicate | | |
| Mix Ratio (lb/gal) | 1.12 | 1.11 |
| Viscosity (cP) | | |
| 10 minute | 683 | 650 |
| 24-hr | 700 | 700 |
| pH | 6.51 | 6.75 |
| Specific Gravity | 1.057 | 1.056 |
| R.I. (10440) | 10.5 | 10.5 |
| Steel Corrosion | | |
| RT/T | 0.2 | 0.2 |
| RT/P | 1.9 | 1.8 |
| ET/T | 2.0 | 1.1 |
| ET/P | 7.0 | 4.9 |
| Aluminum Corrosion | | |
| RT/T | 0.1 | 0.1 |
| RT/P | 0.0 | 0.1 |
| ET/T | 0.9 | 1.2 |
| ET/P | 0.1 | 1.3 |
| Brass Corrosion | | |
| ET/P | 0.0 | 0.0 |

C

| | % | % Dilute |
|---|---|---|
| Tripotassium citrate | 83.92 | 10.01 |
| Fugtive pigment | 2.65 | 0.32 |
| Iron Oxide | 0.25 | 0.03 |
| Xanthan | 3.75 | 0.45 |
| Tolyltriazole | 0.25 | 0.03 |
| Sodium molybdate | 0.17 | 0.02 |
| Tricalcium phosphate | 1.25 | 0.15 |
| Dimercaptothiadiazole | 1.69 | 0.20 |
| Citric Acid | 2.90 | 0.35 |
| Calcium Phosphosilicate | 3.00 | 0.36 |
| Surfactant | 0.17 | 0.02 |
| Total | 100 | |

| Calcium | 1.03 |
|---|---|
| Phosphosilicate:Citric | |
| Acid | |
| Citric Acid:Calcium | 0.97 |
| Phosphosilicate | |
| Mix Ratio (lb/gal) | 1.13 |
| Viscosity (cP) | |
| 10 minute | 650 |
| 24-hr | 683 |
| pH | 6.37 |
| Specific Gravity | 1.065 |
| R.I. (10440) | 10.6 |
| Steel Corrosion | |
| RT/T | 0.2 |
| RT/P | 2.3 |
| ET/T | 1.4 |
| ET/P | 7.1 |
| Aluminum Corrosion | |
| RT/T | 0.1 |
| RT/P | 0.1 |
| ET/T | 0.7 |
| ET/P | 0.8 |
| Brass Corrosion | |
| ET/P | 0.0 |

| | D | | E | |
|---|---|---|---|---|
| | | % | | % |
| | % | Dilute | % | Dilute |
| Tripotassium citrate | 83.96 | 10.02 | 84.82 | 10.12 |
| Fugitive pigment | 2.65 | 0.32 | 2.65 | 0.32 |
| Iron Oxide | 0.25 | 0.03 | 0.25 | 0.03 |
| Xanthan | 3.75 | 0.45 | 3.75 | 0.45 |
| Tolyltriazole | 0.25 | 0.03 | 0.25 | 0.03 |
| Sodium molybdate | 0.17 | 0.02 | 0.17 | 0.02 |
| Tricalcium phosphate | 1.25 | 0.15 | 1.25 | 0.15 |
| Dimercaptothiadiazole | 1.69 | 0.20 | 1.69 | 0.20 |
| Citric Acid | 2.11 | 0.25 | 1.25 | 0.15 |
| Calcium Phosphosilicate | 3.75 | 0.45 | 3.75 | 0.45 |
| Pluronic L-101 | 0.17 | 0.02 | 0.17 | 0.02 |
| Total | 100 | | 100 | |

| Calcium | 1.78 | 3.00 |
|---|---|---|
| Phosphosilicate:Citric | | |
| Acid | | |
| Citric Acid:Calcium | 0.56 | 0.33 |
| Phosphosilicate | | |
| Mix Ratio (lb/gal) | 1.13 | 1.13 |
| Viscosity (cP) | | |
| 10 minute | 650 | 650 |
| 24-hr | 683 | 700 |
| pH | 6.48 | 6.62 |
| Specific Gravity | 1.062 | 1.06 |
| R.I. (10440) | 10.5 | 10.5 |
| Steel Corrosion | | |
| RT/T | 0.2 | 0.2 |
| RT/P | 2.2 | 1.8 |
| ET/T | 1.0 | 0.6 |
| ET/P | 6.0 | 4.7 |
| Aluminum Corrosion | | |
| RT/T | 0.1 | 0.1 |
| RT/P | 0.1 | 0.1 |
| ET/T | 0.7 | 1.0 |
| ET/P | 0.6 | 0.9 |
| Brass Corrosion | | |
| ET/P | 0.0 | 0.0 |

The following results provide viscosity testing for Formulations A-D discussed above. All viscosity measurements were taken at approximately 20° C.

| | | | 10 | 24 | 7- | 14- | % Δ 14 | 30- | % Δ 30 |
|---|---|---|---|---|---|---|---|---|---|
| Formulation | Storage Condition | | Min | hr | day | day | day/24 hr | day | day/24 hr |
| A | 70° F. | w/st | 650 | 700 | 700 | 700 | 0 | 667 | −5 |
| | | w/o st | | | 700 | 700 | 0 | 683 | −2 |
| | 90° F. | w/st | | | 683 | 733 | 5 | 683 | −2 |
| | | w/o st | | | 716 | 767 | 10 | 667 | −5 |
| B | 70° F. | w/st | 650 | 683 | 650 | 700 | 2 | 667 | −2 |
| | | w/o st | | | 667 | 700 | 2 | 667 | −2 |
| | 90° F. | w/st | | | 667 | 733 | 7 | 667 | −2 |
| | | w/o st | | | 683 | 767 | 7 | 683 | 0 |

| | | | 60- | % Δ 60 |
|---|---|---|---|---|
| Formulation | Storage Condition | | day | day/24 hr |
| A | 70° F. | w/st | 733 | 5 |
| | | w/o st | 750 | 7 |
| | 90° F. | w/st | 667 | −5 |
| | | w/o st | 700 | 0 |
| B | 70° F. | w/st | 667 | −2 |
| | | w/o st | 683 | 0 |
| | 90° F. | w/st | 667 | −2 |
| | | w/o st | 667 | −2 |

| | | 90- | % Δ 90 | 180- | % Δ 180 |
|---|---|---|---|---|---|
| Formulation | Storage Condition | day | day/24 hr | day | day/24 hr |

| | | | | | | |
|---|---|---|---|---|---|---|
| A | 70° F. | w/st | 700 | 0 | 617 | −12 |
| | | w/o st | 733 | 5 | 600 | −14 |
| | 90° F. | w/st | 833 | 19 | 650 | −7 |
| | | w/o st | 850 | 21 | 633 | −10 |
| B | 70° F. | w/st | 700 | 2 | 583 | −15 |
| | | w/o st | 717 | 5 | 550 | −19 |
| | 90° F. | w/st | 750 | 10 | 650 | −5 |
| | | w/o st | 733 | 7 | 617 | −10 |

| | | | 10 | 24 | 7- | 14- | % Δ 14 | 30- | % Δ 30 |
|---|---|---|---|---|---|---|---|---|---|
| Formulation | Storage Condition | | Min | hr | day | day | day/24 hr | day | day/24 hr |
| C | 70° F. | w/st | 650 | 683 | 683 | 667 | −2 | 650 | −5 |
| | | w/o st | | | 650 | 700 | 2 | 650 | −5 |
| | 90° F. | w/st | | | 650 | 700 | 2 | 700 | 2 |
| | | w/o st | | | 667 | 700 | 2 | 667 | −2 |
| D | 70° F. | w/st | 650 | 700 | 667 | 717 | 2 | 650 | −7 |
| | | w/o st | | | 700 | 733 | 5 | 667 | −5 |
| | 90° F. | w/st | | | 700 | 716 | 2 | 650 | −7 |
| | | w/o st | | | 683 | 750 | 7 | 667 | −5 |

| | | | 60- | % Δ 60 |
|---|---|---|---|---|
| Formulation | Storage Condition | | day | day/24hr |
| C | 70° F. | w/st | 700 | 2 |
| | | w/o st | 733 | 7 |
| | 90° F. | w/st | 667 | −2 |
| | | w/o st | 717 | 5 |
| D | 70° F. | w/st | 700 | 0 |
| | | w/o st | 667 | −5 |
| | 90° F. | w/st | 683 | −2 |
| | | w/o st | 683 | −2 |

| | | 90- | % Δ 90 | 180- | % Δ 180 |
|---|---|---|---|---|---|
| Formulation | Storage Condition | day | day/24 hr | day | day/24 hr |

| | | | | | | |
|---|---|---|---|---|---|---|
| C | 70° F. | w/st | 700 | 2 | 633 | −7 |
| | | w/o st | 700 | 2 | 617 | −10 |
| | 90° F. | w/st | 700 | 2 | 683 | 0 |
| | | w/o st | 733 | 7 | 617 | −10 |
| D | 70° F. | w/st | 717 | 2 | 600 | −14 |
| | | w/o st | 733 | 5 | 600 | −14 |
| | 90° F. | w/st | 717 | 2 | 650 | −7 |
| | | w/o st | 800 | 14 | 617 | −12 |

The following Examples describe powder concentrate formulations, diluted at a mix ratio of 1.13 pounds (lb) of concentrate per gallon of water for testing.

### Example 2

The following Example describes formulation, viscosity, and metal corrosion testing data for two powder concentrate compositions incorporating a calcium phosphosilicate corrosion inhibitor (CW-491).

| | 2A | 2B |
|---|---|---|
| Weight Percent | % | % |
| Tripotassium Citrate | 84.82 | 84.82 |
| Fugitive Pigment | 2.65 | 2.65 |
| Iron oxide | 0.25 | 0.25 |
| Xanthan | 3.75 | 3.75 |
| Tolyltriazole | 0.25 | 0.25 |
| Sodium Molybdate | 0.17 | 0.17 |
| Tricalcium Citrate | 1.25 | 1.25 |
| Dimercapto Thiadiazole | 1.69 | 1.69 |
| Citric acid | 1.25 | 1.25 |
| CW-491 calcium phosphosilicate based | 3.75 | 3.75 |
| Pluronic L-101 | 0.17 | 0.17 |
| Total | 100 | 100 |

| Mix Ratio (lb/gal) | 1.13 |
|---|---|
| MR (g/mL) | 0.135 |
| Viscosity (cP) | |
| 10 minute | 650 |
| 24-hr | 650 |
| pH | 6.83 |
| 24-hr Specific Gravity | 1.071 |
| R.I. (10440) | 10.6 |

| | | |
|---|---|---|
| Steel Corrosion | | |
| RT/T | 0.2 | 0.2 |
| RT/P | 2 | 2 |
| ET/T | 2.6 | 1.4 |
| ET/P | 4.5 | 5.1 |
| Aluminum Corrosion | | |
| RT/T | 0.1 | 0.1 |
| RT/P | 0.1 | 0.1 |
| ET/T | 1.9 | 1.6 |
| ET/P | 1.7 | 1.6 |
| Magnesium Corrosion | | |
| RT/T | 6.9 | 7.1 |
| RT/P | 6.6 | 5.7 |
| ET/T | 37.6 | 38.2 |
| ET/P | 22 | 22.4 |
| Brass Corrosion | | |
| ET/P | 0.1 | 0.1 |

### Example 3

The following Example describes formulation, viscosity, and metal corrosion testing data for a composition incorporating a calcium phosphosilicate corrosion inhibitor (HMH).

| | 3 |
|---|---|
| Weight Percent | % |
| Tripotassium Citrate | 84.82 |
| Fugitive Pigment | 2.65 |
| Iron oxide | 0.25 |
| Xanthan | 3.75 |
| Tolyltriazole | 0.25 |
| Sodium Molybdate | 0.17 |
| Tricalcium Citrate | 1.25 |
| Dimercapto Thiadiazole | 1.69 |
| Citric acid | 1.25 |
| HMH calcium phosphosilicate based | 3.75 |
| Pluronic L-101 | 0.17 |
| Total | 100 |
| Mix Ratio (lb/gal) | 1.13 |
| MR (g/mL) | 0.135 |
| Viscosity (cP) | |
| 10 minute | 650 |
| 24-hr | 650 |
| pH | 7.03 |
| 24-hr Specific Gravity | 1.071 |
| R.I. (10440) | 10.5 |
| Steel Corrosion | |
| RT/T | 0.2 |
| RT/P | 1.9 |
| ET/T | 0.6 |
| ET/P | 4.5 |
| Aluminum Corrosion | |
| RT/T | 0.2 |
| RT/P | 0.2 |
| ET/T | 4.2 |
| ET/P | 2.4 |
| Magnesium Corrosion | |
| RT/T | 5.7 |
| RT/P | 3.4 |
| ET/T | 5.2 |
| ET/P | 3.8 |
| Brass Corrosion | |
| ET/P | 0 |

### Example 4

The following Example describes formulation, viscosity, and metal corrosion testing data for a composition incorporating a calcium phosphosilicate corrosion inhibitor (CW-491).

| | 4 |
|---|---|
| Weight Percent | % |
| Tripotassium Citrate | 86.51 |
| Fugitive Pigment | 2.65 |
| Iron oxide | 0.25 |
| Xanthan | 3.75 |
| Tolyltriazole | 0.25 |
| Sodium Molybdate | 0.17 |
| Tricalcium Citrate | 1.25 |
| Citric acid | 1.25 |
| CW-491 calcium phosphosilicate based | 3.75 |
| Pluronic L-101 | 0.17 |
| Total | 100 |
| Mix Ratio (lb/gal) | 1.13 |
| MR (g/mL) | 0.135 |
| Viscosity (cP) | |
| 10 minute | 650 |
| 24-hr | 650 |
| pH | 7.14 |
| 24-hr Specific Gravity | 1.07 |
| R.I. (10440) | 10.3 |
| Steel Corrosion | |
| RT/T | 0.3 |
| RT/P | 2 |
| ET/T | 3.5 |
| ET/P | 5.9 |
| Aluminum Corrosion | |
| RT/T | 0 |
| RT/P | 0 |
| ET/T | 0.1 |
| ET/P | 0.3 |
| Magnesium Corrosion | |
| RT/T | 9.5 |
| RT/P | 5.4 |
| ET/T | 3.1 |
| ET/P | 2.3 |
| Brass Corrosion | |
| ET/P | 0 |

### Example 5

The following Example describes formulation, viscosity, and metal corrosion testing data for a composition incorporating a calcium sodium phosphosilicate corrosion inhibitor.

| | 5 |
|---|---|
| Weight Percent | % |
| Tripotassium Citrate | 84.82 |
| Fugitive Pigment | 2.65 |
| Iron oxide | 0.25 |
| Xanthan | 3.75 |
| Tolyltriazole | 0.25 |
| Sodium Molybdate | 0.17 |
| Tricalcium Citrate | 1.25 |
| Dimercapto Thiadiazole | 1.69 |
| Citric acid | 1.25 |
| Calcium sodium phosphosilicate | 3.75 |
| Pluronic L-101 | 0.17 |
| Total | 100 |
| Mix Ratio (lb/gal) | 1.13 |
| MR (g/mL) | 0.135 |
| Viscosity (cP) | |
| 10 minute | 600 |
| 24-hr | 650 |
| pH | 10.04 |
| 24-hr Specific Gravity | 1.07 |
| R.I. (10440) | 10.6 |
| Steel Corrosion | |
| RT/T | 0.1 |
| RT/P | 1.3 |
| ET/T | 0.2 |
| ET/P | 3 |
| Aluminum Corrosion | |
| RT/T | 0 |
| RT/P | 0 |
| ET/T | 0 |
| ET/P | 0.2 |
| Magnesium Corrosion | |
| RT/T | 2 |
| RT/P | 1.4 |
| ET/T | 2.1 |
| ET/P | 1.5 |
| Brass Corrosion | |
| ET/P | 0.1 |

### Example 6

The following Example describes formulation, viscosity, and metal corrosion testing data for a composition incorporating a calcium phosphosilicate corrosion inhibitor.

| | 6 |
|---|---|
| Weight Percent | % |
| Tripotassium Citrate | 84.82 |
| Fugitive Pigment | 2.65 |
| Iron oxide | 0.25 |
| Xanthan | 3.75 |
| Tolyltriazole | 0.25 |
| Sodium Molybdate | 0.17 |
| Tricalcium Citrate | 1.25 |
| Dimercapto Thiadiazole | 1.69 |
| Citric acid | 1.25 |
| CW-491 calcium phosphosilicate based | 3.75 |
| Pluronic L-101 | 0.17 |
| Total | 100 |
| Mix Ratio (lb/gal) | 1.13 |
| MR (g/mL) | 0.135 |
| Viscosity (cP) | |
| 10 minute | 650 |
| 24-hr | 650 |
| pH | 6.96 |
| 24-hr Specific Gravity | 1.069 |
| R.I. (10440) | 10.6 |
| Steel Corrosion | |
| RT/T | 0.1 |
| RT/P | 1.5 |
| ET/T | 1.2 |
| ET/P | 4.6 |
| Aluminum Corrosion | |
| RT/T | 0.1 |
| RT/P | 0.1 |
| ET/T | 1.4 |
| ET/P | 1.2 |
| Magnesium Corrosion | |
| RT/T | 6.4 |
| RT/P | 3.6 |
| ET/T | 37.7 |
| ET/P | 20.8 |
| Brass Corrosion | |
| ET/P | 0.1 |

### Example 7

The following Example describes formulation, viscosity, and metal corrosion testing data for a composition incorporating a calcium phosphate corrosion inhibitor.

| | 7 |
|---|---|
| Weight Percent | % |
| Tripotassium Citrate | 84.82 |
| Fugitive Pigment | 2.65 |
| Iron oxide | 0.25 |
| Xanthan | 3.75 |
| Tolyltriazole | 0.25 |
| Sodium Molybdate | 0.17 |
| Tricalcium Citrate | 1.25 |
| Dimercapto Thiadiazole | 1.69 |
| Citric acid | 1.25 |
| Calcium phosphate | 3.75 |
| Pluronic L-101 | 0.17 |
| Total | 100 |
| Mix Ratio (lb/gal) | 1.13 |
| MR (g/mL) | 0.135 |
| Viscosity (cP) | |
| 10 minute | 650 |
| 24-hr | 650 |
| pH | 6.84 |
| 24-hr Specific Gravity | 1.07 |
| R.I. (10440) | 10.6 |
| Steel Corrosion | |
| RT/T | 0.2 |
| RT/P | 2.3 |
| ET/T | 1.4 |
| ET/P | 6.3 |
| Aluminum Corrosion | |
| RT/T | 0.1 |
| RT/P | 0.1 |
| ET/T | 1 |
| ET/P | 1.2 |
| Magnesium Corrosion | |
| RT/T | 7.4 |
| RT/P | 4.4 |
| ET/T | 26.1 |
| ET/P | 14.5 |
| Brass Corrosion | |
| ET/P | 0 |

### Example 8

The following Example describes formulation, viscosity, and metal corrosion testing data for a composition incorporating a potassium tripolyphosphate corrosion inhibitor.

| | 8 |
|---|---|
| Weight Percent | % |
| Tripotassium Citrate | 84.82 |
| Fugitive Pigment | 2.65 |
| Iron oxide | 0.25 |
| Xanthan | 3.75 |
| Tolyltriazole | 0.25 |
| Sodium Molybdate | 0.17 |
| Tricalcium Citrate | 1.25 |
| Dimercapto Thiadiazole | 1.69 |
| Citric acid | 1.25 |
| Potassium tripolyphosphate | 3.75 |
| Pluronic L-101 | 0.17 |
| Total | 100 |
| Mix Ratio (lb/gal) | 1.13 |
| MR (g/mL) | 0.135 |
| Viscosity (cP) | |
| 10 minute | 750 |
| 24-hr | 650 |
| pH | 6.65 |
| 24-hr Specific Gravity | 1.07 |
| R.I. (10440) | 10.7 |
| Steel Corrosion | |
| RT/T | 0.2 |
| RT/P | 4.2 |
| ET/T | 4.9 |
| ET/P | 15.1 |
| Aluminum Corrosion | |
| RT/T | 0.4 |
| RT/P | 0.4 |
| ET/T | 5.1 |
| ET/P | 5.3 |
| Magnesium Corrosion | |
| RT/T | 10.3 |
| RT/P | 6.2 |
| ET/T | 18.8 |
| ET/P | 9.9 |
| Brass Corrosion | |
| ET/P | 0 |

### Example 9

The following Example describes formulation, viscosity, and metal corrosion testing data for a composition incorporating a sodium dihydrogen phosphate.

| | 9 |
|---|---|
| Weight Percent | % |
| Tripotassium Citrate | 84.82 |
| Fugitive Pigment | 2.65 |
| Iron oxide | 0.25 |
| Xanthan | 3.75 |
| Tolyltriazole | 0.25 |
| Sodium Molybdate | 0.17 |
| Tricalcium Citrate | 1.25 |
| Dimercapto Thiadiazole | 1.69 |
| Citric acid | 1.25 |
| Sodium dihydrogen phosphate | 3.75 |
| Pluronic L-101 | 0.17 |
| Total | 100 |
| Mix Ratio (lb/gal) | 1.13 |
| MR (g/mL) | 0.135 |
| Viscosity (cP) | |
| 10 minute | 650 |
| 24-hr | 733 |
| pH | 6.43 |
| 24-hr Specific Gravity | 1.069 |
| R.I. (10440) | 10.7 |
| Steel Corrosion | |
| RT/T | 0.2 |
| RT/P | 3.5 |
| ET/T | 11.1 |
| ET/P | 19 |
| Aluminum Corrosion | |
| RT/T | 0.1 |
| RT/P | 0.1 |
| ET/T | 1.3 |
| ET/P | 1.8 |
| Magnesium Corrosion | |
| RT/T | 12.3 |
| RT/P | 6.3 |
| ET/T | 14.5 |
| ET/P | 7.8 |
| Brass Corrosion | |
| ET/P | 0 |

### Example 10

The following Example describes formulation, viscosity, and metal corrosion testing data for a composition incorporating a magnesium phosphate trihydrate corrosion inhibitor.

| | 10 |
|---|---|
| Weight Percent | % |
| Tripotassium Citrate | 84.82 |
| Fugitive Pigment | 2.65 |
| Iron oxide | 0.25 |
| Xanthan | 3.75 |
| Tolyltriazole | 0.25 |
| Sodium Molybdate | 0.17 |
| Tricalcium Citrate | 1.25 |
| Dimercapto Thiadiazole | 1.69 |
| Citric acid | 1.25 |
| Magnesium phosphate trihydrate | 3.75 |
| Pluronic L-101 | 0.17 |
| Total | 100 |
| Mix Ratio (lb/gal) | 1.13 |
| MR (g/mL) | 0.135 |
| Viscosity (cP) | |
| 10 minute | 650 |
| 24-hr | 650 |
| pH | 6.75 |
| 24-hr Specific Gravity | 1.068 |
| R.I. (10440) | 10.6 |
| Steel Corrosion | |
| RT/T | 0.2 |
| RT/P | 2.4 |
| ET/T | 2.3 |
| ET/P | 17.1 |
| Aluminum Corrosion | |
| RT/T | 0.1 |
| RT/P | 0.1 |
| ET/T | 1.2 |
| ET/P | 1.5 |
| Magnesium Corrosion | |
| RT/T | 7.9 |
| RT/P | 4.3 |
| ET/T | 9.9 |
| ET/P | 5 |
| Brass Corrosion | |
| ET/P | 0 |

### Example 11

The following Example describes formulation, viscosity, and metal corrosion testing data for a composition incorporating a calcium molybdate corrosion inhibitor (HMH).

| | 11 |
|---|---|
| Weight Percent | % |
| Tripotassium Citrate | 84.82 |
| Fugitive Pigment | 2.65 |
| Iron oxide | 0.25 |
| Xanthan | 3.75 |
| Tolyltriazole | 0.25 |
| Sodium Molybdate | 0.17 |
| Tricalcium Citrate | 1.25 |
| Dimercapto Thiadiazole | 1.69 |
| Citric acid | 1.25 |
| Calcium molybdate | 3.75 |
| Pluronic L-101 | 0.17 |
| Total | 100 |
| Mix Ratio (lb/gal) | 1.13 |
| MR (g/mL) | 0.135 |
| Viscosity (cP) | |
| 10 minute | 650 |
| 24-hr | 667 |
| pH | 6.88 |
| 24-hr Specific Gravity | 1.068 |
| R.I. (10440) | 10.6 |
| Steel Corrosion | |
| RT/T | 0.1 |
| RT/P | 2.3 |
| ET/T | 1.3 |
| ET/P | 6.6 |
| Aluminum Corrosion | |
| RT/T | 0.1 |
| RT/P | 0.2 |
| ET/T | 3.9 |
| ET/P | 1.8 |
| Magnesium Corrosion | |
| RT/T | 12.9 |
| RT/P | 8 |
| ET/T | 27.3 |
| ET/P | 13.8 |
| Brass Corrosion | |
| ET/P | 0 |

### Example 12

The following Example describes formulation, viscosity, and metal corrosion testing data for a composition incorporating a ferric pyrophosphate corrosion inhibitor (HMH).

| | 12 |
|---|---|
| Weight Percent | % |
| Tripotassium Citrate | 84.82 |
| Fugitive Pigment | 2.65 |
| Iron oxide | 0.25 |
| Xanthan | 3.75 |
| Tolyltriazole | 0.25 |
| Sodium Molybdate | 0.17 |
| Tricalcium Citrate | 1.25 |
| Dimercapto Thiadiazole | 1.69 |
| Citric acid | 1.25 |
| Ferric pyrophosphate | 3.75 |
| Pluronic L-101 | 0.17 |
| Total | 100 |
| Mix Ratio (lb/gal) | 1.13 |
| MR (g/mL) | 0.135 |
| Viscosity (cP) | |
| 10 minute | 650 |
| 24-hr | 650 |
| pH | 6.53 |
| 24-hr Specific Gravity | 1.067 |
| R.I. (10440) | 10.4 |
| Steel Corrosion | |
| RT/T | 1.3 |
| RT/P | 6 |
| ET/T | 23.8 |
| ET/P | 24.3 |
| Aluminum Corrosion | |
| RT/T | 0.1 |
| RT/P | 0.2 |
| ET/T | 1.7 |
| ET/P | 1.9 |
| Magnesium Corrosion | |
| RT/T | 55.5 |
| RT/P | 32 |
| ET/T | 77.8 |
| ET/P | 119.1 |
| Brass Corrosion | |
| ET/P | 0 |

### Example 13

The following Example describes formulation, viscosity, and metal corrosion testing data for a composition incorporating a calcium aluminum polyphosphate corrosion inhibitor.

| | 13 |
|---|---|
| Weight Percent | % |
| Tripotassium Citrate | 84.82 |
| Fugitive Pigment | 2.65 |
| Iron oxide | 0.25 |
| Xanthan | 3.75 |
| Tolyltriazole | 0.25 |
| Sodium Molybdate | 0.17 |
| Tricalcium Citrate | 1.25 |
| Dimercapto Thiadiazole | 1.69 |
| Citric acid | 1.25 |
| Calcium aluminum polyphosphate | 3.75 |
| Pluronic L-101 | 0.17 |
| Total | 100 |
| Mix Ratio (lb/gal) | 1.13 |
| MR (g/mL) | 0.135 |
| Viscosity (cP) | |
| 10 minute | 650 |
| 24-hr | 667 |
| pH | 6.59 |
| 24-hr Specific Gravity | 1.069 |
| R.I. (10440) | 10.4 |
| Steel Corrosion | |
| RT/T | 0.3 |
| RT/P | 1.8 |
| ET/T | 2.6 |
| ET/P | 6.3 |
| Aluminum Corrosion | |
| RT/T | 0.2 |
| RT/P | 0.2 |
| ET/T | 4.7 |
| ET/P | 4.2 |
| Magnesium Corrosion | |
| RT/T | 6.5 |
| RT/P | 3.7 |
| ET/T | 7.7 |
| ET/P | 4 |
| Brass Corrosion | |
| ET/P | 0 |

### Example 14

The following Example describes formulation, viscosity, and metal corrosion testing data for a composition incorporating a strontium aluminum polyphosphate corrosion inhibitor.

| | 14 |
|---|---|
| Weight Percent | % |
| Tripotassium Citrate | 84.82 |
| Fugitive Pigment | 2.65 |
| Iron oxide | 0.25 |
| Xanthan | 3.75 |
| Tolyltriazole | 0.25 |
| Sodium Molybdate | 0.17 |
| Tricalcium Citrate | 1.25 |
| Dimercapto Thiadiazole | 1.69 |
| Citric acid | 1.25 |
| Strontium aluminum polyphosphate | 3.75 |
| Pluronic L-101 | 0.17 |
| Total | 100 |
| Mix Ratio (lb/gal) | 1.13 |
| MR (g/mL) | 0.135 |
| Viscosity (cP) | |
| 10 minute | 650 |
| 24-hr | 650 |
| pH | 6.67 |
| 24-hr Specific Gravity | 1.069 |
| R.I. (10440) | 10.5 |
| Steel Corrosion | |
| RT/T | 0.2 |
| RT/P | 1.8 |
| ET/T | 5.4 |
| ET/P | 34.5 |
| Aluminum Corrosion | |
| RT/T | 0.2 |
| RT/P | 0.1 |
| ET/T | 2.5 |
| ET/P | 3.2 |
| Magnesium Corrosion | |
| RT/T | 12.3 |
| RT/P | 6.4 |
| ET/T | 13.6 |
| ET/P | 6.8 |
| Brass Corrosion | |
| ET/P | 0 |

### Example 15

The following Example describes formulation, viscosity, and metal corrosion testing data for a composition incorporating a calcium orthophosphate corrosion inhibitor.

| | 15 |
|---|---|
| Weight Percent | % |
| Tripotassium Citrate | 84.82 |
| Fugitive Pigment | 2.65 |
| Iron oxide | 0.25 |
| Xanthan | 3.75 |
| Tolyltriazole | 0.25 |
| Sodium Molybdate | 0.17 |
| Tricalcium Citrate | 1.25 |
| Dimercapto Thiadiazole | 1.69 |
| Citric acid | 1.25 |
| Calcium orthophosphate | 3.75 |
| Pluronic L-101 | 0.17 |
| Total | 100 |
| Mix Ratio (lb/gal) | 1.13 |
| MR (g/mL) | 0.135 |
| Viscosity (cP) | |
| 10 minute | 617 |
| 24-hr | 650 |
| pH | 7.02 |
| 24-hr Specific Gravity | 1.07 |
| R.I. (10440) | 10.6 |
| Steel Corrosion | |
| RT/T | 0.1 |
| RT/P | 1.5 |
| ET/T | 1.7 |
| ET/P | 5.8 |
| Aluminum Corrosion | |
| RT/T | 0.1 |
| RT/P | 0.1 |
| ET/T | 1.1 |
| ET/P | 1.1 |
| Magnesium Corrosion | |
| RT/T | 6.6 |
| RT/P | 3.8 |
| ET/T | 8.7 |
| ET/P | 4.6 |
| Brass Corrosion | |
| ET/P | 0 |

### Example 16

The following Example describes formulation, viscosity, and metal corrosion testing data for a composition incorporating a calcium magnesium phosphate corrosion inhibitor.

| | 16 |
|---|---|
| Weight Percent | % |
| Tripotassium Citrate | 84.82 |
| Fugitive Pigment | 2.65 |
| Iron oxide | 0.25 |
| Xanthan | 3.75 |
| Tolyltriazole | 0.25 |
| Sodium Molybdate | 0.17 |
| Tricalcium Citrate | 1.25 |
| Dimercapto Thiadiazole | 1.69 |
| Citric acid | 1.25 |
| Calcium magnesium phosphate | 3.75 |
| Pluronic L-101 | 0.17 |
| Total | 100 |
| Mix Ratio (lb/gal) | 1.13 |
| MR (g/mL) | 0.135 |
| Viscosity (cP) | |
| 10 minute | 650 |
| 24-hr | 650 |
| pH | 6.9 |
| 24-hr Specific Gravity | 1.069 |
| R.I. (10440) | 10.6 |
| Steel Corrosion | |
| RT/T | 0.2 |
| RT/P | 2.6 |
| ET/T | 1.6 |
| ET/P | 8.8 |
| Aluminum Corrosion | |
| RT/T | 0.1 |
| RT/P | 0.1 |
| ET/T | 0.9 |
| ET/P | 1 |
| Magnesium Corrosion | |
| RT/T | 7.4 |
| RT/P | 4.1 |
| ET/T | 41.9 |
| ET/P | 18.5 |
| Brass Corrosion | |
| ET/P | 0 |

### Example 17

The following Example describes formulation, viscosity, and metal corrosion testing data for a composition incorporating a calcium sodium phosphosilicate corrosion inhibitor.

| | 17 |
|---|---|
| | % |
| Tripotassium Citrate | 84.82 |
| Fugitive Pigment | 2.65 |
| Iron oxide | 0.25 |
| Xanthan | 3.75 |
| Tolyltriazole | 0.25 |
| Sodium Molybdate | 0.17 |
| Tricalcium Citrate | 1.25 |
| Dimercapto Thiadiazole | 1.69 |
| Citric acid | 1.25 |
| CW-491 calcium phosphosilicate based | 3.75 |
| Calcium sodium phosphosilicate | 0.17 |
| Total | 100 |
| Mix Ratio (lb/gal) | 1.13 |
| MR (g/mL) | 0.135 |
| Viscosity (cP) | |
| 10 minute | 650 |
| 24-hr | 650 |
| pH | 7.02 |
| 24-hr Specific Gravity | 1.067 |
| R.I. (10440) | 10.5 |
| Steel Corrosion | |
| RT/T | 0.1 |
| RT/P | 1.5 |
| ET/T | 1 |
| ET/P | 5.6 |
| Aluminum Corrosion | |
| RT/T | 0 |
| RT/P | 0 |
| ET/T | 0.6 |
| ET/P | 0.8 |
| Magnesium Corrosion | |
| RT/T | 26.6 |
| RT/P | 14.8 |
| ET/T | 42 |
| ET/P | 24.2 |
| Brass Corrosion | |
| ET/P | 0 |

### Example 18

The following Example describes formulation, viscosity, and metal corrosion testing data for a composition incorporating a zinc phosphate corrosion inhibitor.

| | 18 |
|---|---|
| Tripotassium Citrate | % |
| Fugitive Pigment | 84.82 |
| Iron oxide | 2.65 |
| Xanthan | 0.25 |
| Tolyltriazole | 3.75 |
| Sodium Molybdate | 0.25 |
| Tricalcium Citrate | 0.17 |
| Dimercapto Thiadiazole | 1.25 |
| Citric acid | 1.69 |
| Zinc phosphate | 3.75 |
| Pluronic L-101 | 0.17 |
| Total | 100 |
| Mix Ratio (lb/gal) | 1.13 |
| MR (g/mL) | 0.135 |
| Viscosity (cP) | |
| 10 minute | 650 |
| 24-hr | 650 |
| pH | 7.02 |
| 24-hr Specific Gravity | 1.067 |
| R.I. (10440) | 10.5 |
| Steel Corrosion | |
| RT/T | 0.1 |
| RT/P | 1.5 |
| ET/T | 1 |
| ET/P | 5.6 |
| Aluminum Corrosion | |
| RT/T | 0 |
| RT/P | 0 |
| ET/T | 0.6 |
| ET/P | 0.8 |
| Magnesium Corrosion | |
| RT/T | 26.6 |
| RT/P | 14.8 |
| ET/T | 42 |
| ET/P | 24.2 |
| Brass Corrosion | |
| ET/P | 0 |

### Example 19

The following Example provides compositional data for a corrosion inhibitor selected from calcium phosphate, calcium molybdate, calcium aluminum polyphosphate, calcium orthophosphate, and calcium citrate.

| | % | % | % | % | % | % |
|---|---|---|---|---|---|---|
| Weight Percent | | | | | | |
| Tripotassium Citrate | 83.81 | 83.81 | 83.81 | 83.81 | 84.82 | 83.81 |
| Fugitive Pigment | 2.65 | 2.65 | 2.65 | 2.65 | 2.65 | 2.65 |
| Iron oxide | 0.25 | 0.25 | 0.25 | 0.25 | 0.25 | 0.25 |
| Xanthan | 3.5 | 3.5 | 3.5 | 3.5 | 3.75 | 3.5 |
| Tolyltriazole | 0.25 | 0.25 | 0.25 | 0.25 | 0.25 | 0.25 |
| Sodium Molybdate | 0.17 | 0.17 | 0.17 | 0.17 | 0.17 | 0.17 |
| Tricalcium Citrate | 1.25 | 1.25 | 1.25 | 1.25 | 1.25 | 1.25 |
| Dimercapto Thiadiazole | 1.69 | 1.69 | 1.69 | 1.69 | 1.69 | 1.69 |
| Citric acid | 1.25 | 1.25 | 1.25 | 1.25 | 1.25 | 1.25 |
| Calcium phosphate | 5.01 | — | — | — | — | — |
| Potassium tripolyphosphate | — | — | — | — | — | — |
| Sodium dihydrogen phosphate | — | — | — | — | — | — |
| Magnesium phosphate tryhydrate | — | — | — | — | — | — |
| Calcium molybdate | — | 5.01 | — | — | — | — |
| Ferric pyrophosphate | — | — | — | — | — | — |
| Calcium aluminium polyphosphate | — | — | 5.01 | — | — | — |
| Strontium aluminium polyphosphate | — | — | — | — | — | — |
| Calcium orthophosphate | — | — | — | 5.01 | — | — |
| Calcium magnesium phosphate | — | — | — | — | — | — |
| Zinc phosphate | — | — | — | — | — | — |
| Calcium Citrate | — | — | — | — | 3.75 | 5.01 |
| Pluronic L-101 | 0.17 | 0.17 | 0.17 | 0.17 | 0.17 | 0.17 |
| Total | 100 | 100 | 100 | 100 | 100 | 100 |
| Mix Ratio (lb/gal) | 1.13 | 1.13 | 1.13 | 1.13 | 1.13 | 1.13 |
| Viscosity (cP) | | | | | | |
| 10 minute | 600 | 600 | 600 | 600 | 650 | 600 |
| 24-hr | 600 | 600 | 600 | 600 | 650 | 600 |
| pH | 6.84 | 7.25 | 6.92 | 7.05 | 6.62 | 6.56 |
| 24-hr Specific Gravity | 1.073 | 1.073 | 1.073 | 1.073 | 1.068 | 1.068 |
| R.I. (10440) | 10.4 | 10.7 | 10.4 | 10.6 | 10.8 | 10.8 |

### EMBODIMENTS

For additional illustration, further and preferred embodiments of the preset invention are set forth below.

Embodiment 1 is directed to a fire retardant concentrate, the concentrate comprising: an alkali metal salt of a tri-carboxylic acid, wherein the alkali metal salt of the tri-carboxylic acid constitutes at least about 80 wt % of the concentrate; a tri-carboxylic acid, wherein the tri-carboxylic acid constitutes from about 1 wt % to about 2 wt % of the concentrate; and a corrosion inhibitor component, wherein the corrosion inhibitor component comprises: a silicate-based corrosion inhibitor selected from the group consisting of calcium silicate, calcium strontium phosphosilicate, modified calcium phosphosilicates, sodium silicate, sodium metasilicate, calcium sodium phosphosilicate, potassium silicate, barium phosphosilicate, strontium phosphosilicate, zinc silicate, strontium zinc phosphosilicate, and zinc strontium calcium phosphosilicate., and combinations thereof.

Embodiment 2 is directed the fire retardant concentrate of Embodiment 1, wherein the tri-carboxylic acid constitutes between 1 wt % and 2 wt % of the concentrate.

Embodiment 3 is directed to a fire retardant concentrate, the concentrate comprising: an alkali metal salt of a tri-carboxylic acid, wherein the alkali metal salt of the tri-carboxylic acid constitutes at least about 80 wt % of the concentrate; a tri-carboxylic acid, wherein the tri-carboxylic acid constitutes at least about 0.5 wt % of the concentrate; and a corrosion inhibitor component, wherein the corrosion inhibitor component comprises a silicate-based corrosion inhibitor selected from the group consisting calcium silicate, calcium strontium phosphosilicate, modified calcium phosphosilicates, sodium silicate, sodium metasilicate, calcium sodium phosphosilicate, potassium silicate, barium phosphosilicate, strontium phosphosilicate, zinc silicate, strontium zinc phosphosilicate, and zinc strontium calcium phosphosilicate., and combinations thereof, and wherein the weight ratio of the silicate-based corrosion inhibitor to the tri-carboxylic acid is at least 1.8:1.

Embodiment 4 is directed to the fire retardant concentrate of Embodiment 3, wherein the weight ratio of the silicate-based corrosion inhibitor to the tri-carboxylic acid is at least about 1.9:1, at least about 2:1, at least about 2.1:1, at least about 2.2:1, at least about 2.3:1, at least about 2.4:1, at least about 2.5:1, at least about 2.6:1, at least about 2.7:1, at least about 2.8:1, at least about 2.9:1, or at least about 3:1.

Embodiment 5 is directed a fire retardant concentrate, the concentrate comprising: an alkali metal salt of a tri-carboxylic acid; a tri-carboxylic acid; and a corrosion inhibitor component comprising a silicate-based corrosion inhibitor, wherein: the weight ratio of the alkali metal salt of the tri-carboxylic acid to the tri-carboxylic acid is at least 40:1.

Embodiment 6 is directed to the fire retardant concentrate of Embodiment 5, wherein the weight ratio of the alkali metal salt of the tri-carboxylic acid to the tri-carboxylic acid is from 40:1 to about 70:1.

Embodiment 7 is directed to the fire retardant concentrate of any of the preceding Embodiments, wherein the concentrate is particulate.

Embodiment 8 is directed to the fire retardant concentrate of any of the preceding Embodiments, wherein the tri-carboxylic acid of the alkali metal salt is selected from the group consisting of citric acid, isocitric acid, aconitic acid, agaric acid, trimesic acid, propane 1, 2, 3 tricarboxylic acid, and combinations thereof.

Embodiment 9 is directed to a fire retardant concentrate of any of the preceding Embodiments, wherein the alkali metal of the alkali metal salt is selected from the group consisting of lithium, sodium, potassium, calcium, cesium, rubidium, and combinations thereof.

Embodiment 10 is directed to the fire retardant concentrate of any of the preceding Embodiments, wherein the alkali metal of the alkali metal salt is selected from the group consisting of sodium, potassium, and combinations thereof.

Embodiment 11 is directed to the fire retardant concentrate of any of the preceding Embodiments, comprising an alkali metal salt of citric acid.

Embodiment 12 is directed to the fire retardant concentrate of any of the preceding Embodiments wherein the alkali metal salt is tripotassium citrate.

Embodiment 13 is directed to the fire retardant concentrate of any of the preceding Embodiments, wherein the alkali metal salt constitutes at least about 81 wt %, at least about 82 wt %, at least about 83 wt %, at least about 84 wt %, or at least about 85 wt % of the concentrate.

Embodiment 14 is directed to the fire retardant concentrate of any of the preceding Embodiments, wherein the tri-carboxylic acid constitutes at least about 0.5 wt %, at least about 0.6 wt %, at least about 0.7 wt %, at least about 0.8 wt %, at least about 0.9 wt %, at least about 1 wt %, at least about 1.1 wt %, at least about 1.2 wt %, at least about 1.3 wt %, at least about 1.4 wt %, at least about 1.5 wt %, at least about 1.6 wt %, at least about 1.7 wt %, at least about 1.8 wt %, at least about 1.9 wt %, or at least about 2 wt % of the concentrate.

Embodiment 15 is directed to the fire retardant concentrate of any of the preceding claims, wherein the corrosion inhibitor component constitutes at least about 3 wt %, at least about 3.1 wt %, at least about 3.2 wt %, at least about 3.3 wt %, at least about 3.4 wt %, or at least about 3.5 wt %.

Embodiment 16 is directed to the fire retardant concentrate of any of the preceding Embodiments, wherein the corrosion inhibitor component comprises an azole corrosion inhibitor and/or a molybdate corrosion inhibitor.

Embodiment 17 is directed to the fire retardant concentrate of any of the preceding Embodiments, wherein the corrosion inhibitor component comprises an azole corrosion inhibitor, a molybdate corrosion inhibitor, and a silicate-based corrosion inhibitor.

Embodiment 18 is directed to the fire retardant concentrate of any of Embodiments 16 or 17 wherein the corrosion inhibitor component comprises an azole corrosion inhibitor selected from benzotriazole, tolytriazole, dimercaptothiadiazole and combinations thereof.

Embodiment 19 is directed to the fire retardant concentrate of any of Embodiments 16 to 18 wherein the corrosion inhibitor component comprises a molybdate corrosion inhibitor selected from the group consisting of sodium molybdate, potassium molybdate, lithium molybdate, and combinations thereof.

Embodiment 20 is directed to the fire retardant concentrate of any of Embodiments 17 to 19 wherein the weight ratio of the azole corrosion inhibitor to molybdate corrosion inhibitor typically is at least about 1:1, from about 1:1 to about 2:1, or about 1.5:1.

Embodiment 21 is directed to the fire retardant concentrate of any of Embodiments 15 to 20 wherein the corrosion inhibitor component comprises a silicate-based corrosion inhibitor selected from the group consisting of calcium phosphosilicate, calcium strontium phosphosilicate, calcium sodium phosphosilicate, and modified calcium phosphosilicates, and combinations thereof.

Embodiment 22 is directed to the fire retardant concentrate composition of Embodiment 21 wherein the silicate-based corrosion inhibitor is incorporated at a concentration of at least about 2.5 wt %, at least about 2.6 wt %, at least about 2.7 wt %, at least about 2.8 wt %, at least about 2.9 wt %, at least about 3.0 wt %, from about 2.5 wt % to about 4 wt %, or from about 3 wt % to about w 4 wt %.

Embodiment 23 is directed to the fire retardant concentrate composition of Embodiment 21 or 22 wherein, on the basis of total corrosion inhibitor content, any silicate-based corrosion inhibitor typically constitutes at least about 50 wt %, at least about 60 wt %, at least about 70 wt %, at least about 75 wt %, or even at least about 80 wt % of the total corrosion inhibitor content.

Embodiment 24 is directed to the fire retardant concentrate composition of any of Embodiments 21 to 23 wherein the weight ratio of the silicate-based corrosion inhibitor to the tri-carboxylic acid is at least 1.8:1, at least about 1.9:1, at least about 2:1, at least about 2.1:1, at least about 2.2:1, at least about 2.3:1, at least about 2.4:1, at least about 2.5:1, at least about 2.6:1, at least about 2.7:1, at least about 2.8:1, at least about 2.9:1, or at least about 3:1.

Embodiment 25 is directed to the fire retardant concentrate of any of the preceding Embodiments further comprising a thickener is selected from the group consisting of xanthan gum, rhamsan gum, welan gum, diutan gum, guar gum, and combinations thereof.

Embodiment 26 is directed to the fire retardant concentrate of Embodiment 25 wherein the thickener comprises xanthan gum.

Embodiment 27 is directed to the fire retardant concentrate of Embodiment 25 or 26 wherein the thickener constitutes from about 3.5 wt % to about 4.5 wt % of the concentrate.

Embodiment 28 is directed to a powder fire retardant concentrate, the concentrate comprising: an alkali metal salt of a tri-carboxylic acid; a tri-carboxylic acid; a thickener; a corrosion inhibitor component comprising an azole corrosion inhibitor and a molybdate corrosion inhibitor, wherein the weight ratio of the azole corrosion inhibitor to molybdate corrosion inhibitor is at least about 1:1, from about 1:1 to about 2:1, or about 1.5:1; and a flow conditioner.

Embodiment 29 is directed to a powder fire retardant concentrate, the concentrate comprising: an alkali metal salt of a tri-carboxylic acid, wherein the tri-carboxylic acid is selected from the group consisting of citric acid, isocitric acid, aconitic acid, agaric acid, trimesic acid, propane 1, 2, 3 tricarboxylic acid, and combinations thereof; a thickener selected from the group consisting of xanthan gum, rhamsan gum, welan gum, diutan gum, guar gum, and combinations thereof; a corrosion inhibitor selected from the group consisting of azole corrosion inhibitors, molybdate corrosion inhibitors, and combinations thereof; and a flow conditioner, wherein the flow conditioner is selected from the group consisting of phosphate flow conditioners, silicate flow conditioners, oxide flow conditioners, silica flow conditioners, cellulose containing flow conditioners, and combinations thereof.

Embodiment 30 is directed to a liquid fire retardant concentrate comprising the fire retardant concentrate of any of the preceding Embodiments and water.

Embodiment 31 is directed to a fire retardant solution comprising the fire retardant concentrate of any of the preceding Embodiments and water.

Embodiment 32 is directed to a fire retardant solution of Embodiment 31, wherein the solution exhibits any or all of the following properties: viscosity after storage for 10 minutes of from about 150 centipoise (cP) to about 1500 cP; and/or viscosity after storage for 24 hours of from about 150 to about 1500 cP; and/or a pH of at least about 6.5, at least about 7.0, at least about 7.5, at least about 8.0, at least about 8.5, at least about 9.0. at least about 9.5, or at least about 10.0; and/or a specific gravity of at least 1 or from about 1 to about 1.1; and/or a refractive index (R.I.) of at least 10 or from 10 to about 10.5.

Embodiment 33 is directed to the fire retardant solution of Embodiment 31 or 32, wherein: the fire retardant solution exhibits an aluminum corrosion rate equal to or less than 2.0 milli-inches or less than 1.0 milli-inches per year; and/or the fire retardant solution exhibits a mild steel corrosion rate equal to or less than 5.0 milli-inches per year; and/or the fire retardant solution exhibits a brass corrosion rate equal to or less than 5.0 milli-inches per year; and/or the fire retardant solution exhibits two or more of the above-described corrosion rates for magnesium, aluminum, mild steel and/or brass; and/or the fire retardant solution meets one or more of the required criteria for of U.S. Department of Agriculture, Forest Service, Specification Number 5100-304d, January 2020, including any and all amendments; and/or the fire retardant solution meets one or more of the required criteria for corrosion and/or stability of U.S. Department of Agriculture, Forest Service, Specification Number 5100-304d, January 2020, including all amendments; and/or the fire retardant solution meets all of the required criteria for corrosion of U.S. Department of Agriculture, Forest Service, Specification Number 5100-304d, January 2020, including all amendments; and/or the fire retardant solution meets all of the required criteria for stability of U.S. Department of Agriculture, Forest Service, Specification Number 5100-304d, January 2020, including all amendments; and/or the fire retardant solution meets all of the required criteria for corrosion and stability of U.S. Department of Agriculture, Forest Service, Specification Number 5100-304d, January 2020, including all amendments; and/or the fire retardant solution meets all of the required criteria of U.S. Department of Agriculture, Forest Service, Specification Number 5100-304d, January 2020, including all amendments; and/or the fire retardant solution exhibits a viscosity in the range of from about 100 cPs to about 1500 cPs, from about 100 cPa to about 1000 cps, or from about 100 cPs to about 800 cPs, or from about 100 cPs to about 300 cPs when measured in accordance with Specification 5100-304d, January 2020, including any and all amendments; and/or the fire retardant solution exhibits an aquatic toxicity (LC50) in the range of from about 180 milligrams per liter to about 1500 milligrams per liter, an aquatic toxicity (LC50) greater than about 180, 200, 500, 1000, 2000, or 2500 milligrams per liter, or an aquatic toxicity (LC50) in the range of from any of about 180, 200, 500, 750, 1000, 2000, or 2500 milligrams per liter to any of about 200, 500, 1000, 2000, 2500, or 2700 milligrams per liter (e.g., about 980 milligrams per liter).

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above without departing from the scope of the invention, it is intended that all matter contained in the above description shall be interpreted as illustrative and not in a limiting sense.

1. A fire retardant concentrate, the concentrate comprising:
an alkali metal salt of a tri-carboxylic acid, wherein the alkali metal salt of the tri-carboxylic acid constitutes at least about 80 wt % of the concentrate;
a tri-carboxylic acid, wherein the tri-carboxylic acid constitutes from about 1 wt % to about 2 wt % of the concentrate; and
a corrosion inhibitor component, wherein the corrosion inhibitor component comprises:
a silicate-based corrosion inhibitor selected from the group consisting of calcium silicate, calcium strontium phosphosilicate, modified calcium phosphosilicates, sodium silicate, sodium metasilicate, calcium sodium phosphosilicate, potassium silicate, barium phosphosilicate, strontium phosphosilicate, zinc silicate, strontium zinc phosphosilicate, and zinc strontium calcium phosphosilicate., and combinations thereof.

2. The fire retardant concentrate of claim 1, wherein the tri-carboxylic acid constitutes between 1 wt % and 2 wt % of the concentrate.

3. The fire retardant concentrate composition of claim 1, wherein the corrosion inhibitor constitutes from about 2.5 wt % to about 6 wt % of the concentrate.

4. The fire retardant concentrate of claim 1, wherein the tri-carboxylic acid of the alkali metal salt is selected from the group consisting of citric acid, isocitric acid, aconitic acid, agaric acid, trimesic acid, propane 1, 2, 3 tricarboxylic acid, and combinations thereof.

5. The fire retardant concentrate of claim 1, wherein the alkali metal of the alkali metal salt is selected from the group consisting of lithium, sodium, potassium, calcium, cesium, rubidium, and combinations thereof.

6. (canceled)

7. (canceled)

8. (canceled)

9. (canceled)

10. The fire retardant concentrate of claim 1, wherein the tri-carboxylic acid constitutes at least about 0.5 wt % of the concentrate.

11. (canceled)

12. The fire retardant concentrate composition of claim 1, wherein the weight ratio of the silicate-based corrosion inhibitor to the tri-carboxylic acid is at least 1.8:1.

13. The fire retardant concentrate of claim 1, further comprising a thickener selected from the group consisting of latex, styrene, butadiene, polyvinyl alcohol, attapulgite, bentonite, montmorillonite, algin, collagen, casein, albumin, castor oil, cornstarch, arrowroot, yuca starch, carrageenan, pullulan, konjac, alginate, gelatin, agar, pectin, carrageenan, chitosan, xanthan gum, guar gum, rhamsan gum, diutan gum, welan gum, cellulose gum, acacia guar gum, locust bean gum, acacia gum, gum tragacanth, glucomannan polysaccharide gum, alginic acid, sodium alginate, potassium alginate, ammonium alginate, calcium alginate, carboxymethyl cellulose (CMC), methyl cellulose, hydroxyethyl cellulose (HEC), hydroxymethyl cellulose (HMC), hydroxypropyl methylcellulose (HPMC), ethylhydroxymethyl cellulose, hypromellose (INN), cetyl alcohol, cetearyl alcohol, polyethylene glycol (PEG), monoethylene glycol, acrylic microgel, or acrylic amide wax.

14. (canceled)

15. (canceled)

16. (canceled)

17. A fire retardant concentrate, the concentrate comprising:
an alkali metal salt of a tri-carboxylic acid, wherein the alkali metal salt of the tri-carboxylic acid constitutes at least about 80 wt % of the concentrate;
a tri-carboxylic acid, wherein the tri-carboxylic acid constitutes at least about 0.5 wt % of the concentrate; and
a corrosion inhibitor component, wherein the corrosion inhibitor component comprises a silicate-based corrosion inhibitor selected from the group consisting calcium silicate, calcium strontium phosphosilicate, modified calcium phosphosilicates, sodium silicate, sodium metasilicate, calcium sodium phosphosilicate, potassium silicate, barium phosphosilicate, strontium phosphosilicate, zinc silicate, strontium zinc phosphosilicate, and zinc strontium calcium phosphosilicate., and combinations thereof, and wherein the weight ratio of the silicate-based corrosion inhibitor to the tri-carboxylic acid is at least 1.8:1.

18. (canceled)

19. A fire retardant concentrate, the concentrate comprising:
an alkali metal salt of a tri-carboxylic acid;
a tri-carboxylic acid; and
a corrosion inhibitor component comprising a silicate-based corrosion inhibitor, wherein:
the weight ratio of the alkali metal salt of the tri-carboxylic acid to the tri-carboxylic acid is at least 40:1.

20. (canceled)

21. The fire retardant concentrate of claim 1, wherein the concentrate is particulate.

22. A powder fire retardant concentrate, the concentrate comprising:
an alkali metal salt of a tri-carboxylic acid;
a tri-carboxylic acid;
a thickener;
a corrosion inhibitor component comprising an azole corrosion inhibitor and a molybdate corrosion inhibitor, wherein the weight ratio of the azole corrosion inhibitor to molybdate corrosion inhibitor is at least about 1:1, from about 1:1 to about 2:1, or about 1.5:1; and
a flow conditioner.

23. A powder fire retardant concentrate, the concentrate comprising:
an alkali metal salt of a tri-carboxylic acid, wherein the tri-carboxylic acid is selected from the group consisting of citric acid, isocitric acid, aconitic acid, agaric acid, trimesic acid, propane 1, 2, 3 tricarboxylic acid, and combinations thereof;
a thickener selected from the group consisting of xanthan gum, rhamsan gum, welan gum, diutan gum, guar gum, and combinations thereof;
a corrosion inhibitor selected from the group consisting of azole corrosion inhibitors, molybdate corrosion inhibitors, and combinations thereof; and
a flow conditioner, wherein the flow conditioner is selected from the group consisting of phosphate flow conditioners, silicate flow conditioners, oxide flow conditioners, silica flow conditioners, cellulose containing flow conditioners, and combinations thereof.

24. A liquid fire retardant concentrate comprising the fire retardant concentrate of claim 1 and water.

25. A fire retardant solution comprising the fire retardant concentrate of claim 1 and water.

26. The fire retardant solution of claim 25, wherein the solution exhibits any or all of the following properties:
viscosity after storage for 10 minutes of from about 150 centipoise (cP) to about 1500 cP; and/or
viscosity after storage for 24 hours of from about 150 to about 1500 cP; and/or
a pH of at least about 6.0. at least about 6.2, at least about 6.3, at least about 6.5, at least about 7.0, at least about 7.5, at least about 8.0, at least about 8.5, at least about 9.0. at least about 9.5, or at least about 10.0; and/or
a specific gravity of at least 1 or from about 1 to about 1.1; and/or
a refractive index (R.I.) of at least 10 or from 10 to about 10.5.

27. The fire retardant solution of claim 25, wherein:
the fire retardant solution exhibits an aluminum corrosion rate equal to or less than 2.0 milli-inches or less than 1.0 milli-inches per year; and/or
the fire retardant solution exhibits a mild steel corrosion rate equal to or less than 5.0 milli-inches per year; and/or
the fire retardant solution exhibits a brass corrosion rate equal to or less than 5.0 milli-inches per year; and/or
the fire retardant solution exhibits two or more of the above-described corrosion rates for magnesium, aluminum, mild steel and/or brass; and/or
the fire retardant solution meets one or more of the required criteria for of U.S. Department of Agriculture, Forest Service, Specification Number 5100-304d, January 2020, including any and all amendments; and/or
the fire retardant solution meets one or more of the required criteria for corrosion and/or stability of U.S. Department of Agriculture, Forest Service, Specification Number 5100-304d, January 2020, including all amendments; and/or
the fire retardant solution meets all of the required criteria for corrosion of U.S. Department of Agriculture, Forest Service, Specification Number 5100-304d, January 2020, including all amendments; and/or
the fire retardant solution meets all of the required criteria for stability of U.S. Department of Agriculture, Forest Service, Specification Number 5100-304d, January 2020, including all amendments; and/or
the fire retardant solution meets all of the required criteria for corrosion and stability of U.S. Department of Agriculture, Forest Service, Specification Number 5100-304d, January 2020, including all amendments; and/or
the fire retardant solution meets all of the required criteria of U.S. Department of Agriculture, Forest Service, Specification Number 5100-304d, January 2020, including all amendments; and/or
the fire retardant solution exhibits a viscosity in the range of from about 100 cPs to about 1500 cPs, from about 100 cPa to about 1000 cps, or from about 100 cPs to about 800 cPs, or from about 100 cPs to about 300 cPs when measured in accordance with Specification 5100-304d, January 2020, including any and all amendments; and/or
the fire retardant solution exhibits an aquatic toxicity (LC50) in the range of from about 180 milligrams per liter to about 1500 milligrams per liter, an aquatic toxicity (LC50) greater than about 180, 200, 500, 1000, 2000, or 2500 milligrams per liter, or an aquatic toxicity (LC50) in the range of from any of about 180, 200, 500, 750, 1000, 2000, or 2500 milligrams per liter to any of about 200, 500, 1000, 2000, 2500, or 2700 milligrams per liter (e.g., about 980 milligrams per liter).

28. A fire retardant concentrate, the concentrate comprising:
an alkali metal salt of a tri-carboxylic acid, wherein the alkali metal salt of the tri-carboxylic acid constitutes at least about 80 wt % of the concentrate;
a tri-carboxylic acid, wherein the tri-carboxylic acid constitutes from about 1 wt % to about 2 wt % of the concentrate; and
a corrosion inhibitor component, wherein the corrosion inhibitor component comprises:
a phosphate-based corrosion inhibitor selected from the group consisting of calcium phosphate (e.g., hydroxyapatite), calcium orthophosphate (ACP), potassium tripolyphosphate (KTPP), sodium dihydrogen phosphate, magnesium phosphate, magnesium phosphate dibasic trihydrate, zinc phosphate, ferric pyrophosphate, calcium aluminum polyphosphate (CAPP), calcium magnesium phosphate (CMP), strontium aluminum polyphosphate (SAPP), and combinations thereof.

29. A fire retardant concentrate, the concentrate comprising:
an alkali metal salt of a tri-carboxylic acid, wherein the alkali metal salt of the tri-carboxylic acid constitutes at least about 80 wt % of the concentrate;
a tri-carboxylic acid, wherein the tri-carboxylic acid constitutes at least about 0.5 wt % of the concentrate; and
a corrosion inhibitor component, wherein the corrosion inhibitor component comprises a phosphate-based corrosion inhibitor selected from the group consisting of calcium phosphate (e.g., hydroxyapatite), calcium orthophosphate (ACP), potassium tripolyphosphate (KTPP), sodium dihydrogen phosphate, magnesium phosphate, magnesium phosphate dibasic trihydrate, zinc phosphate, ferric pyrophosphate, calcium aluminum polyphosphate (CAPP), calcium magnesium phosphate (CMP), strontium aluminum polyphosphate (SAPP), and combinations thereof, and wherein the weight ratio of the silicate-based corrosion inhibitor to the tri-carboxylic acid is at least 1.8:1.

30. A fire retardant concentrate, the concentrate comprising:
an alkali metal salt of a tri-carboxylic acid;
a tri-carboxylic acid; and
a corrosion inhibitor component comprising a phosphate-based corrosion inhibitor, wherein:
the weight ratio of the alkali metal salt of the tri-carboxylic acid to the tri-carboxylic acid is at least 40:1, wherein the phosphate-based corrosion inhibitor is selected from the group consisting of calcium phosphate (e.g., hydroxyapatite), calcium orthophosphate (ACP), potassium tripolyphosphate (KTPP), sodium dihydrogen phosphate, magnesium phosphate, magnesium phosphate dibasic trihydrate, zinc phosphate, ferric pyrophosphate, calcium aluminum polyphosphate (CAPP), calcium magnesium phosphate (CMP), strontium aluminum polyphosphate (SAPP), and combinations thereof.
